(19) United States
(12) Patent Application Publication
(10) Pub. No.: US 2013/0311434 A1
(43) Pub. Date: Nov. 21, 2013

(54) METHOD, APPARATUS AND SYSTEM FOR DATA DEDUPLICATION

(71) Applicant: Marc T. Jones, Longmont, CO (US)

(72) Inventor: Marc T. Jones, Longmont, CO (US)

(21) Appl. No.: 13/997,966

(22) PCT Filed: Nov. 17, 2011
(86) PCT No.: PCT/US2011/061246

§ 371 Date: Jun. 25, 2013

(51) Int. Cl. G06F 17/30

(52) U.S. Cl. CPC G06F 17/30156
USPC 707/692

(57) ABSTRACT

Techniques and mechanisms for limiting storage of duplicate data in a storage back-end. In an embodiment, a storage device of the storage back-end receives from a storage front-end a write command specifying a write of data to the storage back-end. In another embodiment, the storage device calculates and provides to the storage front-end a data signature for data which is the subject of the write command. Based on the data signature provided by the storage device, a deduplication engine of the storage front-end determines whether a deduplication operation is to be performed.

### BACKGROUND

1. Technical Field

Embodiments discussed herein relate generally to computer data storage. More particularly, certain embodiments variously relate to techniques for providing deduplication of stored data.

2. Background Art

Typically, data deduplication techniques calculate a hash value representing data which is stored in one or more data blocks of a storage system. The hash value is maintained for later reference in a dictionary of hash values which each represent respective data currently stored in the storage system. Subsequent requests to store additional data in the storage system are processed according to whether a hash of the additional data matches any hash value in the dictionary. If the hash for the additional data matches a hash representing currently stored data, the storage system likely already stores a duplicate of the additional data. Consequently, writing the additional data to the storage system can be avoided for the purpose of improving utilization of storage space.

Conventional data deduplication generally relies upon one of two main approaches—deduplication and post-processing deduplication. With in-line deduplication, a storage front-end identifies, before additional data might be written to a storage back-end, whether that additional data is likely a duplicate of some currently stored data. Where such additional data is determined to be a likely duplicate, the storage-front end prevents, in advance, writing of the duplicate additional data to the storage back-end.

With post-processing deduplication, a storage front-end writes the additional data to a storage back-end device. Subsequently, the storage front-end reads the additional data back from the storage back-end and identifies whether the already-written additional data is likely a duplicate of some other currently stored data. Where such already-written additional data is determined to be a likely duplicate, the storage-front end commands the storage back-end to erase the already-written additional data.

In-line deduplication tends to use comparatively less communication bandwidth between storage front-end and storage back-end, and tends to use comparatively fewer storage back-end resources, both of which result in performance savings. However, calculating and checking hashes in-line with servicing a pending write request requires more robust, expensive processing hardware in the storage front-end, and tends to reduce performance of the storage path through the storage front-end. By contrast, post-processing deduplication, which is more common, trades off additional use of communication bandwidth between the storage front-end and the storage back-end, and additional use of storage back-end resources, for lower processing requirements for the storage front-end.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a system to implement storage deduplication according to an embodiment.

FIG. 2 is a block diagram illustrating elements of a system to implement storage deduplication according to an embodiment.

FIG. 3 is a block diagram illustrating elements of a storage front-end to exchange deduplication information according to an embodiment.

FIG. 4 is a block diagram illustrating elements of a storage device to determine deduplication information according to an embodiment.

FIG. 5 is a flow diagram illustrating elements of a method for implementing data deduplication according to an embodiment.

FIG. 6 is a flow diagram illustrating elements of a method for determining data deduplication information according to an embodiment.

FIG. 7 is a block diagram illustrating elements of a computer platform to provide data deduplication information according to an embodiment.

### DETAILED DESCRIPTION

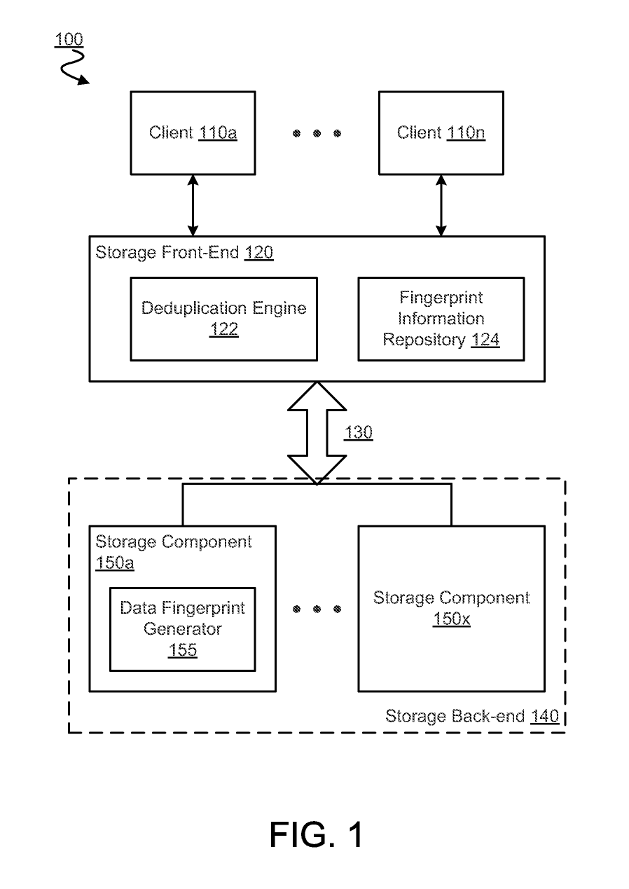

FIG. 1 illustrates elements of a storage system 100 for implementing data deduplication according to an embodiment. Storage system 100 may, for example, include a storage front-end 120 and one or more client devices (represented by illustrative client 110a, . . . , 110n) coupled thereto. Although features of storage system 100 are discussed herein in terms of data storage requested by client 110a, . . . , 110n, such discussion may be extended to apply to any of a variety of one or more additional or alternative clients, according to different embodiments.

One or more of client 110a, . . . , 110n may communicate with a storage back-end 140 of storage system 100—e.g. to variously request data read access and/or data write access to storage back-end 140. Storage front-end 120 may, for example, comprise hardware, firmware and/or software of a computer platform to provide one or more storage management services in support of a request from clients 110a, . . . , 110n. The one or more storage management services provided by storage front-end 120 may include, for example, a data deduplication service to make an evaluation of whether data to be stored in storage back-end 140 might be a duplicate of other data which is already stored in storage back-end 140. For example, storage front-end 120 may include a deduplication engine 122 e.g. hardware, firmware and/or software logic—to perform such deduplication evaluations.

In an embodiment, storage front-end 120 provides one or more additional services in support of data storage by storage back—end 140. By way of illustration and not limitation, storage front-end 120 may provide for one or more security services to protect some or all of storage hack-end 140. For example, storage front-end 120 may include, or otherwise have access to, one or more malware detection, prevention and/or response services—e.g. to reduce the threat of a virus, worm, trojan, spyware and/or other malware affecting operation of, or access to, storage front-end 120. In an embodiment, malware detection may be based at least in part on evaluation of data fingerprint information such as that exchanged according to various techniques discussed herein.

In an embodiment, some or all of storage front-end 120 includes or otherwise resides on, for example, a personal computer such as a desktop computer, laptop computer, a handheld computer—e.g. a tablet, palmtop, cell phone, media player, and/or the like—and/or other such computer for servicing a storage request from a client. Alternatively or in addition, some or all of storage front-end 120 may include a server, workstation, or other such device for servicing such storage requests.

Client 110a, . . . , 110n may be variously coupled to storage front-end 120 by any of a variety of shared communication pathways and/or dedicated communication pathways. By way of illustration and not limitation, some or all of client 110a, . . . , may be coupled to storage front-end 120 by any of a variety of combinations of networks including, but not limited to, one or more of a dedicated storage area network (SAN), a local area network (LAN), a wide area network (WAN), a virtual LAN (ULAN), an Internet, and/or the like.

Storage back-end 140 may include one or more storage components—e.g. represented by illustrative storage components 150a, . . . , 150x—which each include one or more storage devices. Storage back-end 140 may include any of a variety of combinations of one or more additional or alternative storage components, according to different embodiments. Storage components 150a, . . . , 150x may variously include one or more of a hard disk drive, a solid state drive, an optical drive and/or the like. In an embodiment, some or all of storage components 150a, . . . , 150x include respective computer platforms. For example, storage back-end 140 may include multiple networked computer platforms—or alternatively, only a single computer platform—which is distinct from a computer platform that implements storage front-end 120. In an embodiment, storage front-end 120 and at least one storarge device of storage back-end 140 reside on the same computer platform.

Storage back-end 140 may couple to storage front-end 120 via one or more communications channels comprising a hardware interface 130 of storage system 100. Hardware interface 130 may, for example, include one or more networking elements—e.g. including one or more of a switch, router, bridge, hub, and/or the like—to support network communications between a computer platform implementing storage front-end 120 and a computer platform including some or all of storage components 150a, . . . , 150x. Alternatively or in addition, hardware interface 130 may include one or more computer buses—e.g. to couple a processor, chipset and/or other elements of a computer platform implementing storage front-end 120 with other elements of the same computer platform which include some or all of storage components 150a, . . . , 150x. By way of illustration and not limitation, hardware interface 130 may include one or more of a Peripheral Component interconnect (PCI) Express bus, a Serial Advanced Technology Attachment (SATA) compliant bus, a Small Computer System interface (SCSI) bus and/or the like.

In an embodiment, at least one storage component of storage back-end 140 includes logic to locally calculate a data fingerprint for data to be stored by that storage component. By way of illustration and not limitation, storage component 150a may include a data fingerprint generator 155—e.g. hardware, firmware and/or software logic to generate a hash value or other fingerprint value which represents corresponding data that storage front-end 120 has indicated is to be stored by storage component 150a.

Storage component 150a may further include logic to provide to storage front-end 120 information which identifies the data fingerprint calculated by data fingerprint generator 155. Based on the information from storage component 150a, deduplication engine 122 or similar deduplication logic may determine whether the data to be stored in storage component 150a is a duplicate of other information which is already stored in storage back-end 140.

For example, storage front-end 120 may include or otherwise have access to a fingerprint information repository 124 to store fingerprint values that represent respective data which is currently stored in storage back-end 140. Deduplication engine 122 may search fingerprint information repository 124 to determine whether a data fingerprint associated with data already stored in storage back-end 140 matches the data fingerprint corresponding to the data to be stored in storage component 150a. Where a matching data fingerprint is found in fingerprint information repository 124, deduplication engine 122 may initiate one or more remedial actions to prevent or correct a storage of the duplicate data in storage component 150a.

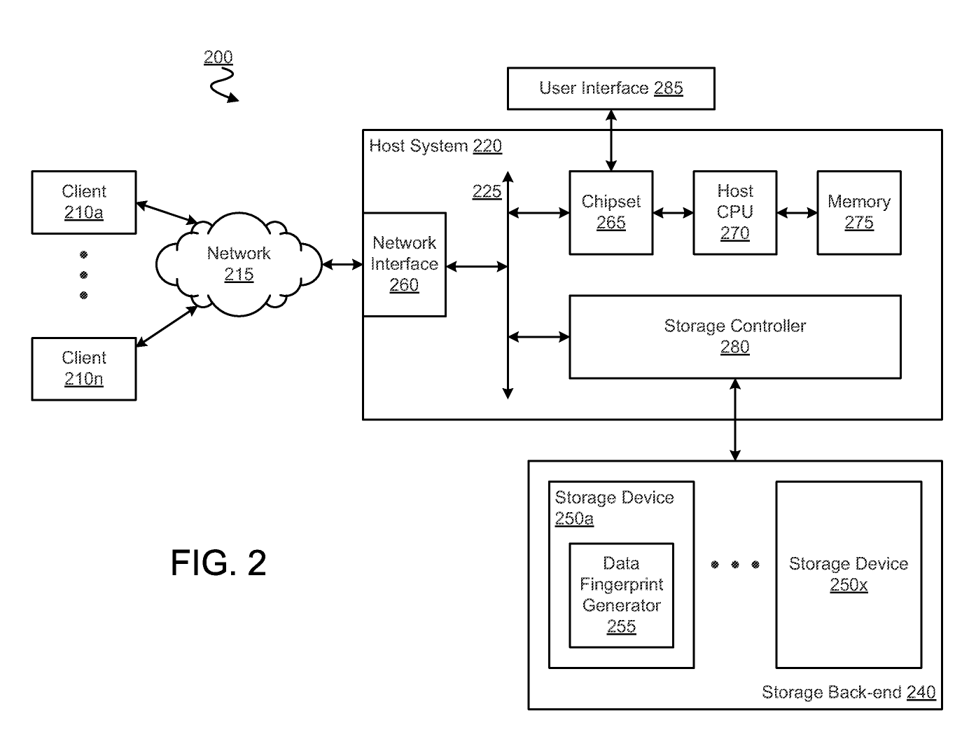

FIG. 2 illustrates elements of a system 200 for implementing data deduplication according to an embodiment. System 200 may include one or more clients 210a, . . . , 210n capable of exchanging commands and data with a storage back-end 240 via a host system 220. Host system 220 may comprise a host central processing unit (CPU) 270 coupled to a chipset 265. Host CPU 270 may comprise, for example, functionality of an Intel® Pentium® IV microprocessor that is commercially available from Intel Corporation of Santa Clara, Calif. Alternatively, host CPU 270 may comprise any of a variety of other types of microprocessors from various manufacturers without departing from this embodiment.

Chipset 265 may, for example, comprise a host bridge/hub system that may couple host CPU 270, a memory 275 and a user interface system 285 to each other and to a bus system 225. Chipset 265 may also include an I/O bridge/hub system (not shown) that may couple the host bridge/bus system to bus system 225. Chipset 265 may comprise integrated circuit chips, including, for example, graphics memory and/or I/O controller hub chipsets components, although other integrated circuit chips may also, or alternatively be used, without departing from this embodiment. User interface system 285 may comprise, e.g., a keyboard, pointing device, and display system that may permit a human user to input commands to, and monitor the operation of, system 200.

Bus system 225 may comprise a bus that complies with the Peripheral Component Interconnect (PCI) Express™ Base Specification Revision 1.0, published Jul. 22, 2002, available from the PCI Special Interest Group, Portland, Oreg., LLS. A. (hereinafter referred to as a “PCI Express™ bus”). Alternatively or in addition, bus system 225 may comprise a bus that complies with the PCI-X Specification Rev. 1.0a, Jul. 24, 2000, available from the aforesaid PCI Special Interest Group, Portland, Oreg., (hereinafter referred to as a “PCI-X bus”). Moreover, bus system 225 may alternatively or in addition comprise one of various other types and configurations of bus systems, without departing from this embodiment. Host CPU 270, system memory 275, chipset 265, bus system 225, and one or more other components of host system 220 may be comprised in a single circuit board, such as, for example, a system motherboard.

In an embodiment, storage front-end functionality may be implemented by one or more processes of host CPU 270 and/or by one or more components of chipset 265. Such front-end functionality may include deduplication logic such as that of deduplication engine 122 e.g. such deduplication logic implemented at least in part by a process executing on host CPU 270. In an embodiment, the storage front-end functionality of host system 220 includes hardware and/or software to control operation of one or more of storage devices 250a, . . . , 250x. By way of illustration and not limitation, such front-end functionality may include a storage controller 280—e.g. an I/O controller hub, platform controller huh, or other such mechanism for controlling the access (e.g. data read access and/or data write access) to storage back-end 240. In an embodiment, storage controller 280 is a component of chipset 265.

Storage back-end 240 may, for example, comprise one or more storage devices—represented by illustrative storage devices 250a, . . . , 250x—which may include, for example, any of a variety of combination of one or more hard disk drives (HDD), solid state drives (SSD) and/or the like. Some or all of storage devices 250a, . . . , 250x may, for example, be accessed independently by a storage controller 280 of host system 220, and/or may be capable of being identified by storage controller 280 using, for example, disk identification (disk ID) information. Alternatively or in addition, some or all of storage devices 250a, . . . , 250x may store data thereon in selected units, for example, logical block address (LBA), sectors, clusters, and/or any combination thereof. Storage back-end 240 may be comprised in one or more respective enclosures that may be separate, for example, from an enclosure in which are enclosed a motherboard of host system 220 and the components comprised therein. Alternatively of in addition, some or all of storage back-end 240 may be integrated into host system 220.

Storage controller 280 may be coupled to and control the operation of storage back-end 240. In an embodiment, storage controller 280 couples to one or more storage devices 250a, . . . , 250x via one or more respective communication links, computer platform bus lines and/or the like. Storage controller 280 may variously exchange data and/or commands with some or all of storage devices 250a, . . . , 250x—e.g. using one or more of a variety of different communication protocols, e.g., Fibre Channel (FC), Serial Advanced Technology Attachment (SATA), and/or Serial Attached Small Computer Systems Interface (SAS) protocol. Alternatively, storage controller 280 may variously exchange data and/or commands with some or all of storage devices 250a, . . . , 250x using other and/or additional communication protocols, without departing from this embodiment.

In accordance with an embodiment, if a FC protocol is used by storage controller 280 to exchange data and/or commands with storage back-end 240, it may comply or be compatible with the interface/protocol described in ANSI Standard Fibre Channel (FC) Physical and Signaling Interface-3 X3.303:1998 Specification. If a SATA protocol is used by storage controller 280 to exchange data and/or commands with storage back-end 240, it may comply or be compatible with the protocol described in the Serial ATA Revision 3.1 Specification, released July 2011 by the Serial ATA International Organization (SATA-IO), or various later or earlier SATA specifications. If a SAS protocol is used by storage controller 280 to exchange data and/or commands with storage back-end 240, it may comply or be compatible with the protocol described in “Information Technology—Serial Attached SCSI (SAS),” Working Draft American National Standard of International Committee For Information Technology Standards (INCITS) T10 Technical Committee, Project T10/1562-D, Revision 2b, published 19 Oct. 2002, by American National Standards Institute (hereinafter termed the “SAS Standard”) and/or later-published versions of the SAS Standard.

Storage controller 280 may be coupled to exchange data and/or commands with system memory 275, host CPU 270, user interface system 285 chipset 265, and/or one or more clients 210a, . . . , 210n via bus system 225. Where bus system 225 comprises a PCI Express™ bus or a PCI-X bus, storage controller 280 may, for example, be coupled to bus system 225 via, for example, a PCI Express™ or PCI-X bus compatible or compliant expansion slot or similar interface (not shown).

Depending on how the media of each of one or more storage devices 250a, . . . , 250x is formatted, storage controller 280 may control read and/or write operations to access disk data in a logical block address (LEA) format, i.e., where data is read from the device in preselected logical block units. Of course, other operations to access disk data stored in one or more storage devices 250a, . . . , 250x—e.g. via a network communication link and/or a computer platform bus—are equally contemplated herein and may comprise, for example, accessing data by cluster, by sector, by byte, and/or other unit measures of data.

Data stored in one or more storage devices 250a, . . . , 250x may be formatted, for example, according to one or more of a File Allocation Table (FAT) format, New Technology File System (NTFS) format, and/or other disk formats. If a storage device is formatted using a FAT format, such a format may comply or be compatible with a formatting standard described in “Microsoft Extensible Firmware Initiative FAT32 File System Specification”, Revision L3, published Dec. 6, 2000 by Microsoft Corporation. If data stored in a mass storage device is formatted using an NTFS format, such a format may comply or be compatible with an NTFS formatting standard, such as may be publicly available.

In an embodiment, at least one storage device in storage back-end 240 includes logic to locally calculate a data fingerprint for data to be stored by that storage component. By way of illustration and not limitation, storage component 250a may include a data fingerprint generator 255—e.g. hardware, firmware and/or software logic—to generate a hash value or other fingerprint value which represents corresponding data that a storage front-end implemented within host system 220 has indicated is to be stored by storage component 250a. The fingerprint value may be provided by data fingerprint generator 255—e.g. for the storage front-end to determine a deduplication operation which may be performed.

The one or more clients 210a, . . . , 210n may each include appropriate network communication circuitry (not shown) to request storage front-end functionality of host system 220 for access to storage back-end 240. Such access may, for example, be via a network 215 including one or more of a local area network (LAN), wide area network (WAN), storage area network (SAN) or other wireless and/or wired network environments.

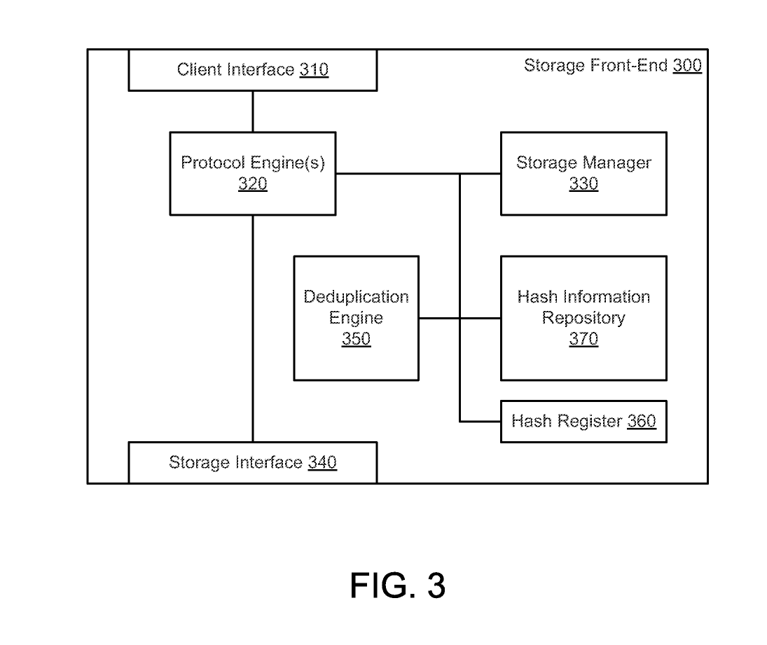

FIG. 3 is a functional representation of elements in a storage front-end 300 for providing data deduplication according to an embodiment, Storage front-end 300 may, for example, include some or all of the features of storage front-end 120. In an embodiment, functional elements of storage front-end 300 are variously implemented by logic—e.g. hardware, firmware and/or software—of a computer platform including some or all of the features of host system 220.

Storage front-end 300 may include a client interface 310 to exchange a communication with a client such as one of clients 210a, . . . , 210n—e.g. to receive a client request for storage front-end 300 to access a storage back-end (not shown). Client interface 310 may include any of a variety of wired and/or wireless network interface logic—e.g. such as that of network interface 260—for communication with such a client. In an embodiment, storage front-end 300 may include one or more protocol engines 320 coupled to client interface 310, the one or more protocol engines 320 to variously support one or more protocols for communication with respective clients. By way of illustration and not limitation, one or more protocol engines 320 may support Network File System (NFS) communications, TCP/IP communications Representational State Transfer (ReST) communications, Internet Small Computer System Interface (iSCSI) communications, Ethernet-based communications such as those via Fibre Channel over Ethernet (FCoE) and/or any of a variety of other protocols for exchanging data storage requests between a client and storage front-end 300. One or more protocol engines 320 may, for example, include dedicated hardware which is part of, or operates under the control of, chipset 265.

The storage back-end may, for example, include one or more storage components coupled directly or indirectly to a storage interface 340 of storage front-end 300. Alternatively or in addition, the storage back-end may include one or more storage components which reside on the computer platform which implements storage front-end 300. Client interface 310 and storage interface 340 may, alternatively, be incorporated into the same physical interface hardware, although certain embodiments are not limited in this regard.

In an embodiment, storage front-end 300 provides one or more management services to support a client's request to store data in the storage back-end. For example, storage front-end 300 may include a storage manager 330—e.g. including hardware such as that in storage controller 280 and/or software logic such as one or more processes executing in host CPU 270—to maintain a hash information repository 370 for data which is currently stored in the storage back-end. Hash information repository 370 may, for example, be located in memory 275 or some non-volatile storage (not shown) of host system 220. In an alternate embodiment, hash repository 370 may be managed by, but nevertheless external to, storage front-end 300—e.g. where hash repository 370 is stored in (e.g. distributed across) one or more storage devices of the storage back-end. Storage manager 330 may maintain any of a variety of additional or alternative data fingerprint repositories for referencing to determine the performing of a deduplication operation. Although features of certain embodiments are discussed herein in terms of the storing, comparing, etc. of hash values, one of ordinary skill in the art would appreciate that such discussion may be extended to any of a variety of additional or alternative types of data fingerprint information.

In an embodiment, hash information repository 370 includes one or more entries which each correspond to respective data stored in the back-end storage. At a given point in time, the one or more entries in hash information repository 370 may each store a respective value representing abash of the stored data which corresponds to that entry. Hash information repository 370 may be updated occasionally by storage manager 330 based on the writing of data to, and/or the deleting of data from, the storage back-end. By way of illustration and not limitation, storage manager 330 may remove an entry from hash information repository 370 based on data which corresponds to that entry being deleted from the storage back-end. Alternatively or in addition, storage manager 330 may revise a hash value stored in an entry of hash information repository 370 based on a write operation modifying the data which corresponds to that entry.

In an embodiment, storage front-end 300 includes a deduplication engine 350 coupled to, or alternatively included in, storage manager 330. Deduplication engine 350 may, for example, be implemented by a process executing in host CPU 270. In an embodiment, deduplication engine 350 evaluates a hash value—e.g. stored in a hash register 360 of storage front-end for data which is under consideration for future valid storing in the storage back-end. Data may be under consideration for future valid storing in a storage back-end if, for example, it has yet to be determined whether the data in question is a duplicate of any other data which is currently stored in the storage back-end. Where the data in question is determined to be duplicate data, the data in question may be prevented from being written to the storage back-end. Alternatively, such data may be deleted from the storage back-end and/or may otherwise be invalidated after its storing in the storage back-end.

In an embodiment, the hash value stored is provided by the storage back-end—e.g. for storage in hash register 360—in response to the data under consideration being sent by the storage front-end for a provisional storing in the storage back-end. Such storing may be considered provisional, for example, at least insofar as such data may be removed or otherwise invalidated subject to a result of the evaluation by deduplication engine 350. Evaluating the hash value in hash register 360 may for example, include deduplication engine 350 searching hash information repository 370 to determine whether any hash value therein matches the value stored in hash register 360.

In an embodiment, storage manager 330 may allow or otherwise implement future valid storing of data in the storage back-end—and may further add a corresponding entry to hash information repository 370—based on storage front-end 300 determining that such data is not a duplicate of data corresponding to any entry already in hash information repository 370. Storage manager 330 may provide any of a variety of additional or alternative storage management services, according to various embodiments. For example, storage manager 330 may determine how data is to be distributed across one or more storage components of a storage back-end. By way of illustration and not limitation, storage manager 330 may select where data should reside in the storage back-end—e.g. including choosing a particular drive to store a copy of the data based on a level of current utilization of that drive, based on an age of the disk, and/or the like. Additionally or alternatively, storage manager 330 may provide authentication and/or authorization services—e.g. to determine a permission of the client to access the storage back-end. Certain embodiments are not limited with regard to any services, in addition to deduplication-related services, which may further be provided by storage manager 330.

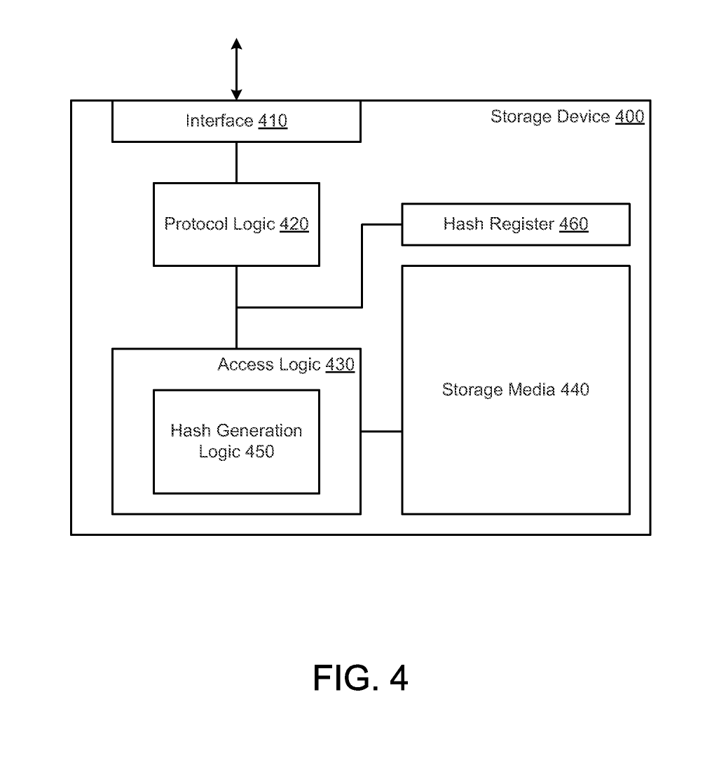

FIG. 4 illustrates functional elements of a storage device 400, according to an embodiment, for providing information in support of data deduplication. Storage device 400 may, for example, include some or all of the features of storage device 250a. In an embodiment, storage device 400 provides data signature information to a storage front-end having some or all of the features of storage front-end 300.

Storage device 400 may include or reside in a computer platform which is distinct from another computer platform implementing storage front-end functionality. Storage device 400 may, for example, include an interface 410 for receiving one or more data storage commands from a platform remote from storage device 400, the platform operating as a storage front-end. In such an embodiment, interface 410 may include any of a variety of wired and/or wireless network interfaces.

Alternatively, storage device 400 may be a component in a computer platform that implements storage front-end functionality for one or more storage back-end components including storage device 400—e.g. where storage device 400 is distinct from logic of the computer platform to implement such storage front-end functionality, in such an embodiment, interface 410 may alternatively include connector hardware to couple storage device 400 directly or indirectly to one or more other components of the platform—e.g. components including one or more of an I/O controller, a processor, a platform controller huh and/or the like. By way of illustration and not limitation, interface 410 may include a Peripheral Component Interconnect (PCI) bus connector, a Peripheral Component Interconnect Express (PCIe) bus connector, a SATA connector, a Small Computer System Interface (SCSI) connector and/or the like. In an embodiment, interface 410 includes circuit logic to send and/or receive one or more commands which comply or are otherwise compatible with a Non-Volatile Memory Host Controller interface (NVMHCI) specification such as the NVMHCI specification 1.0, released April 2008 by the NVMHCI Workgroup, although certain embodiments are not limited in this regard.

Storage device 400 may receive via interface 410 a write command—e.g. a NVMHCI write command—from the storage front-end which specifies a storing of data in a storage media 440 of storage device 400. Storage media 440 may, for example, include one or more of solid-state media—e.g. NAND flash memory, NOR flash memory, etc.—magneto-resistive random access memory, nanowire memory, phase-change memory, magnetic hard disk media, optical disk media and/or the like. In an embodiment, storage device 400 includes protocol logic 420—e.g. circuit logic to evaluate the write command according to a protocol and/or determine one or more operations according to a protocol to act upon or otherwise respond to the write command.

Memory device 400 may further include access logic 430 to implement a write to storage media 440—e.g. as directed by the write command. By way of illustration and not limitation, access logic 430 may include, or otherwise control, logic to operate (e.g. select, latch, drive and/or the like) address signal lines and/or data signal lines (not shown) for writing data to one or more locations in storage media 440. In an embodiment, access logic 430 includes direct memory access logic to access storage media 440 independent of a host processor of storage device 400—e.g. in an embodiment where memory device 400 includes a computer platform having such a host processor.

Access logic 430 may include, or couple to, hash generation logic 450—e.g. circuit logic to perform calculations to generate a hash value representing the data being written to storage media 440.

Hash generation logic 450 may include a state machine or other hardware to receive as input a version of data being written to, or to be written to, storage media 440. Based on the input data, hash generation logic may perform any of a variety of calculations to generate a hash value—e.g. a MD5 Message-Digest Algorithm hash value, a Secure Hash Algorithm SHA-256 hash value or any of a variety of additional or alternative hash values—representing the corresponding data being written to storage media 440. Hash generation logic 450 may store such a hash value—e.g. in a hash register 460—for subsequent sending to the storage front-end. In an embodiment, multiple hash values may be stored—e.g. each to a different one of multiple hash registers—each hash value for a respective portion of data to be written. For example, a 4 KB bulk data write, consisting of 8 512 byte blocks, might require that eight hash values be stored in different respective hash slots, where the eight hash values together are for representing the bulk data.

In an embodiment, protocol logic 420 may include in a reply communication to the storage front-end information to identify the hash value stored in hash register 460. For example, the write command received from the storage front-end via interface 410 may, according to a communication protocol, result in a write response message from the storage back-end to confirm receipt of the message and/or completion of the requested data write. By way of illustration and not limitation, eNVMHCI responds to completion of a command such as a write command by writing status information in a command status field of a register directly visible by a driver or other agent which sent the command. Various embodiments extend such protocols to provide for one or more hash values to be returned in the context of a successful write—e.g. within or in addition to the communication of a command status. For example, protocol logic 420 may provide for an extension of such a protocol—e.g. whereby the value stored in hash register 460 is added to, or otherwise sent in conjunction with, conventional write response communications according to the protocol.

Alternatively, a hash value stored in hash register 460 may be provided in an independent communication performed subsequent to the provisional data write. In an embodiment, a physical or virtual device—e.g. identified by a virtual logical unit number—may store block numbers and their associated hash values in a log. In such an instance, a storage front-end may request a read to pull hash information from the log—e.g. to capture large numbers of hash values in a lazy fashion.

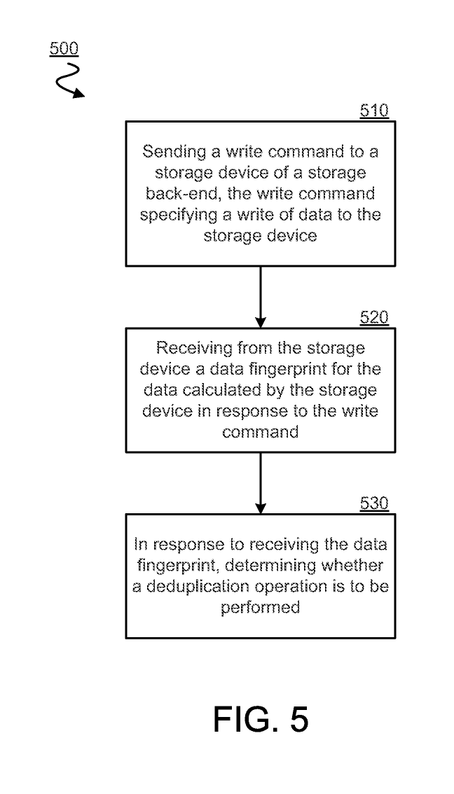

FIG. 5 illustrates select elements of a method 500 for providing data deduplication according to an embodiment. Method 500 may be performed at a storage front-end which, for example, includes some or all of the features of storage front-end 300.

Method 500 may include, at 510, sending a write command from the storage front-end to the storage device of a storage back-end. Such a storage device may, for example, include some or all of the features of storage device 400. The storage front-end may, for example, include at least one of a process executing on a processor of a computer platform and one or more components of a chipset of that computer platform. In such an instance, the storage backend may be coupled to the processor and the chipset via a hardware interface—e.g. a network interface, an bus, and/or the like. For example, the storage device may be a component of same computer platform which includes the processor and the chipset implementing the storage front-end functionality. Alternatively, the storage device may reside within a second computer platform which his networked with the computer platform implementing such storage front-end functionality.

The write command sent at 510 may be provided to the storage device by the storage front-end in response to, or otherwise on behalf of a storage client requesting access to the storage back-end. In an embodiment, the write command specifies a write of first data to the storage device. For example, the write command may include or otherwise be sent with the data in question.

In an embodiment, the storage device stores the data which is the subject of the write command—e.g. where the storing of the data is at least initially on a provisional basis. For example, after initial storing in the storage device, the data may be under consideration for future valid storing in the storage back-end. Such future valid storing may, for example, be contingent upon a determination as to whether the provisionally stored data is a duplicate of any other data already stored in the storage back-end.

In support of such an evaluation, the storage device may, in response to receiving the write command, locally calculate a data fingerprint—e.g. a hash—for the first data. Moreover, the storage device may further send a message communicating the calculated data fingerprint.

Method 500 may include, at 520, receiving from the storage device the data fingerprint for the first data. In response to receiving the data fingerprint, method 500 may, at 530, determine whether a deduplication operation is to be performed. For example, the write command may be exchanged between the storage front-end and the storage device according to a communication protocol. In such an instance, the data fingerprint may be received by the storage front-end at 520 in a response message corresponding to the write command—e.g. where the communication protocol requires such a response message for the write command. One or more additional operations of the storage front-end may be performed based on the receiving of such a response message. For example, prior to the storage device provisionally storing the data, the storage front-end may store a copy of the data—e.g. in a cache of the storage front-end. The storage front-end may further flush such a copy of the first data from cache in response to the response message. A signal may be generated by the storage front-end to communicate a result of such determining at 530.

In an embodiment, the determining at 530 whether the deduplication operation is to be performed includes accessing a repository which includes one or more data fingerprints. The one or more fingerprints may, for example, each represent respective data which is currently stored in the storage back-end. The repository may be searched to determine whether any of the one or more data fingerprints of the repository matches the data fingerprint for the first data. Searching the repository may, for example, include evaluating a data fingerprint which represents data stored in some second storage device of the storage back-end. A match between the data fingerprint and some other data fingerprint may indicate that the data provisionally stored in the storage device is identical to some other information currently stored in the storage back-end e.g. where the other data is stored in the storage device which received the write command or, alternatively, in some other storage device of the storage back-end.

If the first data is determined by the storage front-end to be a duplicate of other data stored in the storage back-end, the storage front-end may further signal that a deduplication operation is to be performed. For example, the data in question may be provisionally stored in a first memory location in the storage device. In such an instance, the deduplication operation may, for example, include deleting the data from the first memory location. Alternatively or in addition, the deduplication operation may include deleting metadata which indicates that the data is stored in the first memory location. The deduplication operation based on the determining at 530 may, for example, include any of a variety of conventional techniques for removing or otherwise invalidating such duplicate data.

In an embodiment, method 500 may further include determining a time and/or manner of any deduplication which, at 530, is determined to be performed. For example, de-duplication may be performed immediately in response to the determining at 530. Alternatively, a deduplication notification may be queued so as to manage such deduplication in a lazy fashion. In an embodiment, deduplication may be performed in response to some load on the storage front-end dropping below some threshold—e.g. the load drop indicating that processing cycles are available to invest in deduplication data scrubbing.

One advantage to the approach of method 500, for example, is that it allows the processing load needed for calculating hashes to scale easily with the number of disks or other storage devices in a storage system. In a traditional storage system, a single node calculates all hashes as the data is moved, which can reduce performance. By contrast, certain embodiments variously allow hash calculation to be pushed (e.g. distributed) to one or multitude remote drives, thereby spreading that processing load and making it easier to scale to larger storage systems.

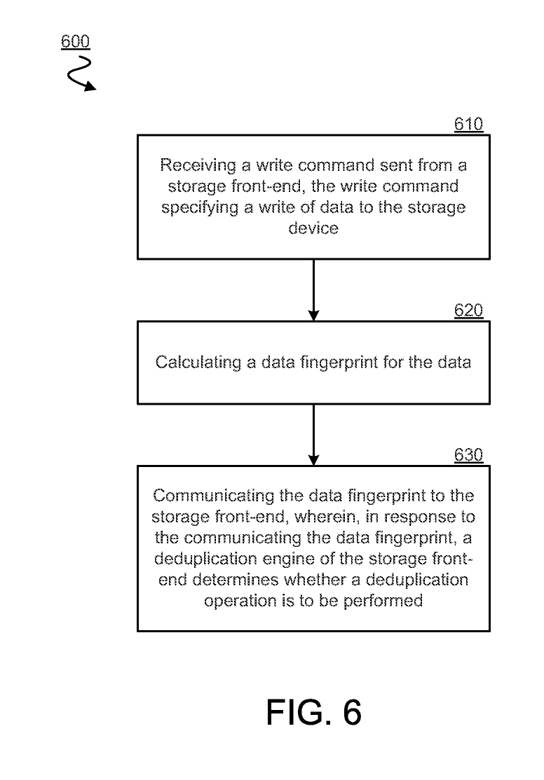

FIG. 6 illustrates select elements of a method 600 for providing information in support of data deduplication according to an embodiment. Method 600 may be performed at a storage device of a storage back-end—for example, a storage device including some or all of the features of storage device 400. In an embodiment, method 600 represents operations of a storage device which are in conjunction with a storage front-end implementing method 500.

Method 600 may include, at 610, receiving a write command sent from a storage front-end, the write command—e.g. a NVMHCI write command—specifying a write of data to the storage device. In an embodiment, the write command specifies a write of first data to the storage device. For example, the write command may include, or otherwise be sent in conjunction with, the data which is the subject of the write command.

In an embodiment, the storage device stores the data which is the subject of the write command—e.g. where the storing of the data is at least initially on a provisional basis. For example, after initial storing in the storage device, the data may be subject to consideration for future valid storing in the storage back-end. Such future valid storing may, for example, be contingent upon a determination as to whether the provisionally stored data is a duplicate of any other data already stored in the storage back-end.

In support of such an evaluation, method 600 may, at 620, include the storage device calculating a data fingerprint for the first data, the calculating in response to receiving the write command. Moreover, the storage device may further communicate the locally-calculated data fingerprint to the storage front-end, at 630. For example, the locally-calculated data fingerprint is communicated in a response to an NVMHCI write command, although certain embodiments are not limited in this regard.

In response to the communicating of the data fingerprint, a deduplication engine of the storage front-end may determine whether a deduplication operation is to be performed. Such determining may, for example, correspond to the determining at 530, for example. In an embodiment, the storage device may receive from the storage front-end a message directing the storage backend to perform a deduplication operation for the data. For example, the data in question may be provisionally stored in a first memory location in the storage device. In such an instance, the deduplication operation may, for example, include the storage device deleting the data from the first memory location. Alternatively or in addition, the deduplication operation may include the storage device deleting or otherwise changing metadata which indicates that the data is validly stored in the first memory location. Alternatively or in addition, metadata stored outside of the storage device may be deleted or otherwise changed by the storage front-end—such changing/deleting to reflect that the data is not validly stored in the first memory location.

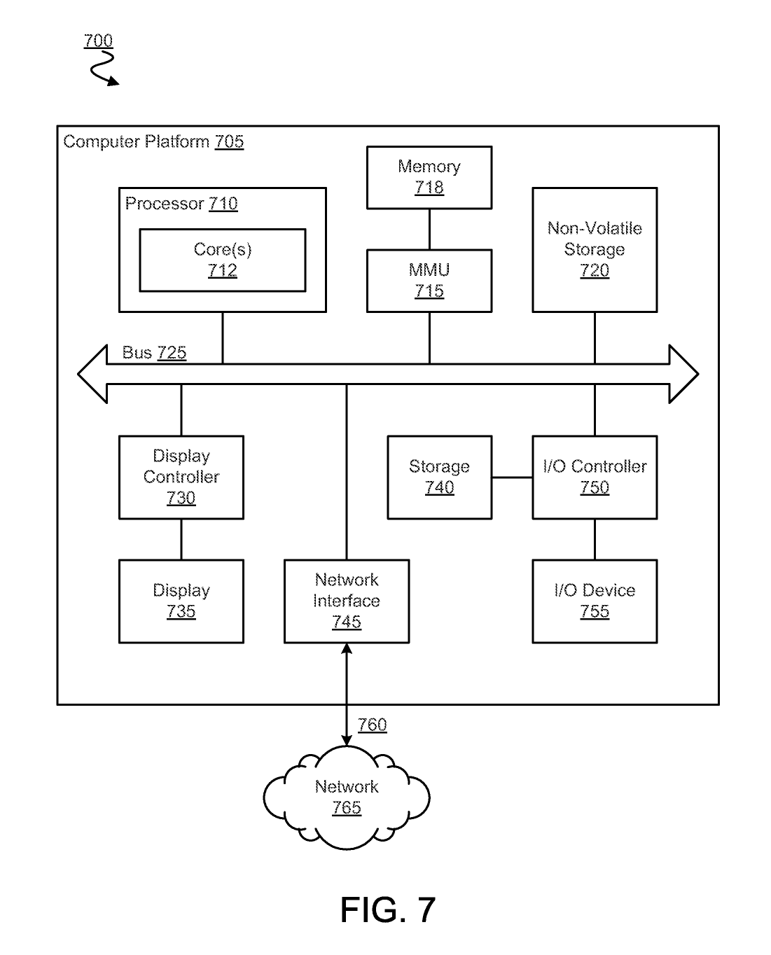

FIG. 7 is an illustration of one embodiment of an example computer system 700 in which embodiments of the present invention may be implemented. In one embodiment, computer system 700 includes a computer platform 705 which, for example, may include some or all of the features of storage component 150a. Computer platform 705 may, for example, include a storage back-end and/or a storage component (e.g. a storage device) which is a component of such a storage back-end.

Computer platform 705 may include a processor 710 coupled to a bus 725, the processor 710 having one or more processor cores 712. Memory 718, storage 740, non-volatile storage 720, display controller 730, input/output controller 750 and modem or network interface 745 are also coupled to bus 725. The computer platform 705 may interface to one or more external devices through the network interface 745. This interface 745 may include a modem. Integrated Services Digital Network (ISDN) modem, cable modem, Digital Subscriber Line (DSL) modem, a T-1 line interface, a T-3 line interface, Ethernet interface, WiFi interface, WiMax interface, Bluetooth interface, or any of a variety of other such interfaces for coupling to another computer. In an illustrative example, a network connection 760 may be established for computer platform 705 to receive and/or transmit communications via network interface 745 with a computer network 765 such as, for example, a local area network (LAN), wide area network (WAN), or the Internet. In one embodiment, computer network 765 is further coupled to a remote computer (not shown) implementing storage front-end functionality.

Processor 710 may include features of a conventional microprocessor including, but not limited to, features of an Intel Corporation x86, Pentium®, or Itanium® processor family microprocessor, a Motorola family microprocessor, or the like. Memory 718 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Display controller 730 may control in a conventional manner a display 735, which in one embodiment may be a cathode ray tube (CRT), a liquid crystal display (LCD), an active matrix display or the like. An input/output device 755 coupled to input/output controller 750 may be a keyboard, disk drive, printer, scanner and other input and output devices, including a mouse, trackball, trackpad, joystick, or other pointing device.

The computer platform 705 may also include non-volatile storage 720 on which firmware and/or data may be stored. Non-volatile storage devices include, but are not limited to Read-Only Memory (ROM), Flash memory, Erasable Programmable Read Only Memory (EPROM), Electronically Erasable Programmable Read Only Memory (EEPROM), or the like.

Storage 740, in one embodiment, may be a magnetic hard disk, an optical disk, or another form of storage for large amounts of data. Some data may be written by a direct memory access process into memory 718 during execution of software in computer platform 705. For example, a memory management unit (MMU) 715 may facilitate DMA exchanges between memory 718 and a peripheral (not shown). Alternatively, memory 718 may be directly coupled to bus 725—e.g. where MMU 715 is integrated into the encore of processor 710—although various embodiments are not limited in this regard. It is appreciated that software and/or data may reside in storage 740, memory 718, non-volatile storage 720 or may be transmitted or received via modem or network interface 745.

Computer platform 705 may receive a write command from a storage front-end (not shown), the write command specifying a write of data to a storage media of computer platform 705. Such data may, for example, be stored to memory 718, storage 740 and/or the like. Data fingerprint generator logic (not shown) of computer platform 705 may reside, for example, in memory management unit 715, I/O controller 750 or other such components of computer platform 705. By way of illustration and not limitation, a DMA engine (not shown) or other such hardware of memory management unit 715 or I/O controller 750 may include or have access to logic for automatically generating a hash or other data fingerprint for data written, being written, or to be written to computer platform 705.

Techniques and architectures for managing data storage are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A method at a first computer platform providing a storage front-end, the method comprising:
sending a write command from the storage front-end to a storage device of a storage back-end, the write command specifying a write of first data to the storage device;
receiving from the storage device a data fingerprint for the first data, the data fingerprint calculated by the storage device in response to the write command;
in response to receiving the data fingerprint, determining whether a deduplication operation is to be performed; and
if the first data is determined to be a duplicate of other data stored in the storage back-end, signaling that the deduplication operation is to be performed.

2. The method of claim 1, wherein the storage font-end includes at least one of:
a process executing on a processor of the first computer platform; and
one or more components of a chipset of the first computer platform;
wherein the storage back-end is coupled to the processor and the chipset via a hardware interface.

3. The method of claim 2, wherein a second computer platform coupled to the first computer platform includes the storage device.

4. The method of claim 1, wherein determining whether the deduplication operation is to be performed includes:
accessing a repository including one or more data fingerprints each representing respective data stored in the storage back-end, and
searching the repository to determine whether any of the one or more data fingerprints of the repository matches the data fingerprint for the first data.

5. The method of claim 1, wherein the storage device is a component of the first computer platform, the method further comprising:
receiving the write command at the storage device;
calculating the data fingerprint with the storage device in response to receiving the write command; and
with the storage device, sending the data fingerprint to the storage front-end.

6. The method of claim 5, wherein the write command is exchanged according to a communication protocol, wherein sending the data fingerprint includes the storage device sending to the storage front-end a response message corresponding to the write command, the response message according to the communication protocol.

7. The method of claim 1, wherein the deduplication operation includes one of:
deleting the first data from a first memory location; and
deleting metadata indicating that the first data is stored in the first memory location.

8. A computer system for providing a storage front-end, the computer system comprising:
a protocol engine of the storage front-end, the protocol engine to send a write command to a storage device of a storage back-end, the write command to specify a write of first data to the storage device;
a deduplication engine of the storage front-end, the deduplication engine to receive from the storage device a data fingerprint for the first data, the data fingerprint calculated by the storage device in response to the write command, the deduplication engine further to determine, based on the received data fingerprint, whether a deduplication operation is to be performed, wherein, if the first data is determined to be a duplicate of other data stored in the storage back-end, the deduplication engine further to signal that the deduplication operation is to be performed.

9. The computer system of claim 8, wherein the storage front-end includes at least one of:
a process executing on a processor of a computer system; and
one or more components of a chipset of the computer system;
wherein the storage back-end is coupled to the processor and the chipset via a hardware interface.

10. The computer system of claim 9, wherein the computer system is coupled to a computer platform including the storage device.

11. The computer system of claim 8, wherein the deduplication engine to determine whether the deduplication operation is to be performed includes:
the deduplication engine to access a repository including one or more data fingerprints each representing respective data stored in the storage back-end; and
the deduplication engine to search the repository to determine whether any of the one or more data fingerprints of the repository matches the data fingerprint for the first data.

12. The computer system of claim 8, further comprising the storage device, wherein the storage device includes:
protocol logic to receive the write command; and
fingerprint generator logic coupled to the protocol logic, the fingerprint generator logic to calculate, in response to the write command, the data fingerprint for the first data;
wherein the protocol logic further to send the data fingerprint to the storage front-end.

13. The computer system of claim 8, wherein the deduplication operation includes one of:
deleting the first data from the first memory location; and
deleting metadata indicating that the first data is stored in the first memory location.

14. The computer system of claim 8, wherein the write command is exchanged according to a communication protocol, wherein communicating the data fingerprint includes the storage device sending to the storage front-end a response message corresponding to the write command, the response message according to the communication protocol.

15. A storage device including:
protocol logic to receive a write command sent from a storage front-end, the write command specifying a write of first data to the storage device; and
fingerprint generator logic coupled to the protocol logic, the fingerprint generator logic to calculate, in response to the received write command, a data fingerprint for the first data
wherein the protocol logic further to communicate the data fingerprint to the storage front-end; and
wherein, in response to communication of the data fingerprint, a deduplication engine of the storage front-end determines whether a deduplication operation is to be performed.

16. The storage device of claim 15, wherein the storage front-end includes at least one of:
a process executing on a processor of a first computer platform; and
one or more components of a chipset of the first computer platform;
wherein the storage back-end is to couple to the processor and the chipset via a hardware interface.

17. The storage device of claim 16, wherein the storage device is to operate as a component of the first computer platform.

18. The storage device of claim 13, wherein the storage device is to operate as a component of a second computer platform coupled to the first computer platform.

19. The storage device of claim 15, wherein the deduplication engine determines, after the first data is stored in a first memory location in the storage device, that the deduplication operation is to be performed, and wherein the deduplication operation includes one of:
deleting the first data from the first memory location; and
deleting metadata indicating that the first data is stored in the first memory location.

20. The storage device of claim 15, wherein the write command is exchanged according to a communication protocol, wherein communicating the data fingerprint includes the storage device sending to the storage front-end a response message corresponding to the write command, the response message according to the communication protocol.
